(19) United States
(12) Patent Application Publication
(10) Pub. No.: US 2010/0274460 A1
(43) Pub. Date: Oct. 28, 2010

(54) CONTROL APPARATUS AND CONTROL METHOD FOR POWER SOURCE

(75) Inventors: Seiji Kuwahara, Toyota-shi (JP); Masato Kaigawa, Toyota-shi (JP); Toshiya Oishi, Toyota-shi (JP); Shogo Matsumoto, Toyota-shi (JP)

Correspondence Address: OLIFF & BERRIDGE, PLC, P.O. BOX 320850, ALEXANDRIA, VA, 22320-4850, US

(73) Assignee: TOYOta JIDOSHA KABUSHIKI KAISHA, toyota-shi, Aichi-ken (JP)

(21) Appl. No.: 12/744,592

(22) PCT Filed: Nov. 14, 2008
(86) PCT No.: PCT/JP2008/071176

§ 371 Date: May 25, 2010

(30) Foreign Application Priority Data
Jan. 15, 2008 (JP) 2008-005887

(51) Int. Cl. G06F 19/00

(52) U.S. Cl. 701/99

(57) ABSTRACT

Static demand engine torque is converted into dynamic demand engine torque. The dynamic demand engine torque converted from the static demand engine torque is accommodated in relation to the dynamic demand engine torque set in another system. Static demand drive force is converted into dynamic demand drive force. The dynamic demand drive force converted from the static demand drive force is accommodated in relation to the dynamic demand drive force set in another system.

### TECHNICAL FIELD

The present invention relates to a control apparatus and a control method of a power source, particularly to a technique for setting a demand value of an output value of a power source and controlling the output value of the power source in accordance with the set demand value.

### BACKGROUND ART

Conventionally, there is a known engine in which a value of output torque or the like is determined by an opening position of a throttle valve (hereinafter, also referred to as a throttle opening position) or the like. In general, the throttle opening position is actuated so as to chiefly correspond to a position of an accelerator pedal (hereinafter, also referred to as an accelerator pedal position). However, when the throttle opening position and the accelerator pedal position always chiefly correspond to each other, drive force of a vehicle or the like is not easily controlled irrespective of an intention of a driver for example in the case where an action of the vehicle is disordered. Therefore, there is a vehicle provided with an electronic throttle valve actuated by an actuator in an engine so as to be capable of controlling the output torque and the like not depending on the accelerator pedal position. In the vehicle provided with the electronic throttle value, it is possible to set demand engine torque based on the action of the vehicle in addition to the accelerator pedal position and control the engine so that actual engine torque is the set demand engine torque.

Japanese Patent Laying-Open No. 2006-290235 discloses a drive force control apparatus including a driver model and a powertrain manager for tuning a characteristic related to human sense other than a hardware characteristic of a vehicle in target transient property addition calculating unit included in the driver model, and tuning the hardware characteristic of the vehicle other than the characteristic related to human sense in a characteristic compensator included in the powertrain manager so as to distinguish the human sense and the hardware characteristic. The driver model calculates target drive force based on a map in which the target drive force is determined by a vehicle speed for example taking the accelerator pedal position as a parameter in a target base drive force calculating unit (static characteristic), and calculates final target drive force by giving a transient property to the target drive force in the target transient property addition calculating unit. The powertrain manager calculates demand engine torque in the characteristic compensator based on the target engine torque outputted from a target engine torque and AT gear calculating unit. In the characteristic compensator, a response property of a vehicle G serving as an acceleration generated in the vehicle, that is, a portion depending on the hardware characteristic of the vehicle is compensated.

When final demand engine torque is set, there is a need to consider dynamic demand engine torque in consideration of the transient property of the engine or the like and also static demand engine torque for example for realizing torque-down or torque-up at the time of shifting of an automatic transmission. The dynamic demand engine torque indicates engine torque in an engine transition state. Meanwhile, the static demand engine torque indicates engine torque in an engine steady state. Therefore, it is not possible to simply compare the dynamic demand engine torque and the static demand engine torque. However, Japanese Patent Laying-Open No. 2006-290235does not describe how the final demand engine torque is set from the dynamic demand engine torque and the static demand engine torque. Therefore, it is not possible to set the final demand engine torque in consideration of both the dynamic demand engine torque and the static demand engine torque. Consequently, there is further room for improving control accuracy of the engine serving as a power source.

### DISCLOSURE OF THE INVENTION

An object of the present invention is to provide a control apparatus and a control method for a power source capable of improving control accuracy of the power source.

A control apparatus for a power source according to one aspect is a control apparatus for a power source with an output value changed in accordance with an actuated amount of a device. This control apparatus comprises a first setter that sets a first demand value being one of a dynamic demand value and a static demand value of the output value, a second setter that sets a second demand value being the other of the dynamic demand value and the static demand value of the output value, a converter that converts the second demand value into a third demand value being the one of the dynamic demand value and the static demand value of the output value, a third setter that sets a fourth demand value of the output value based on the first demand value and the third demand value, and a controller that controls the device in accordance with the fourth demand value.

According to this configuration, the first demand value being one of the dynamic demand value and the static demand value of the output value is set. The second demand value being the other of the dynamic demand value and the static demand value of the output value is converted into the third demand value being one demand value of the dynamic demand value and the static demand value. Accordingly, it is possible to unify a plurality of demand values having different characteristics. The fourth demand value is set based on the obtained first and third demand values. Accordingly, it is possible to set the fourth demand value in consideration of both the dynamic demand value and the static demand value. The device provided in the power source is controlled in accordance with the fourth demand value. Therefore, it is possible to improve the control accuracy of the power source.

Preferably, the third setter sets one of the first demand value and the third demand value as the fourth demand value.

According to this configuration, for example a larger value or a smaller value of the first demand value and the third demand value can be set as the fourth demand value.

Further preferably, the first demand value and the third demand value are the dynamic demand values, the second demand value is the static demand value, and the converter converts the second demand value into the third demand value by adding a delay at the time of controlling the device to the second demand value.

According to this configuration, the dynamic third demand value can be obtained by adding the delay at the time of controlling the device to the static second demand value.

Further preferably, the first demand value and the third demand value are the dynamic demand values, the second demand value is the static demand value, and the converter converts the second demand value into the third demand value by restricting the second demand value in accordance with a response property of the device.

According to this configuration, the dynamic third demand value can be obtained by restricting the static second demand value in accordance with the response property of the device.

Further preferably, the first demand value and the third demand value are the static demand values, the second demand value is the dynamic demand value, and the converter converts the second demand value into the third demand value by subtracting a delay at the time of controlling the device from the second demand value.

According to this configuration, the static third demand value can be obtained by subtracting the delay at the time of controlling the device from the dynamic second demand value.

Further preferably, the first demand value and the third demand value are the static demand values, the second demand value is the dynamic demand value, and the converter converts the second demand value into the third demand value by restricting a value determined by subtracting a delay at the time of controlling the device from the second demand value in accordance with a limit value of the actuated amount of the device.

According to this configuration, the static third demand value can be obtained by restricting the value determined by subtracting the delay at the time of controlling the device from the dynamic second demand value in accordance with the limit value of the actuated amount of the device.

Further preferably, the output value is output torque.

According to this configuration, it is possible to improve the control accuracy of the output torque of the power source.

### BRIEF DESCRIPTION OF THE DRAWINGS

FIG. 1 is a schematic configuration diagram showing a powertrain of a vehicle.

FIG. 2 is a skeleton diagram showing a planetary gear unit of an automatic transmission.

FIG. 3 is a working table of the automatic transmission.

FIG. 4 is a diagram showing an oil hydraulic circuit of the automatic transmission.

FIG. 5 is a diagram showing a system configuration of a control apparatus according to an embodiment.

FIG. 6 is a graph showing static demand engine torque.

FIG. 7 is a diagram showing an engine model represented by a primary delay function.

FIG. 8 is a diagram showing an engine model represented by a secondary delay function.

FIG. 9 is a diagram showing dynamic demand engine torque obtained by restricting the static demand engine torque with a limit value determined in accordance with a response property of a device.

FIG. 10 is a diagram (1) showing a method of converting dynamic demand engine torque/demand drive force into static demand engine torque/demand drive force.

FIG. 11 is a diagram (2) showing a method of converting the dynamic demand engine torque/demand drive force into the static demand engine torque/demand drive force.

### BEST MODES FOR CARRYING OUT THE INVENTION

An embodiment of the present invention will be described below with reference to the drawings. In the following description, the same parts are given the same reference numerals. Names and functions thereof are all the same. Therefore, a detailed description thereof will not be repeated.

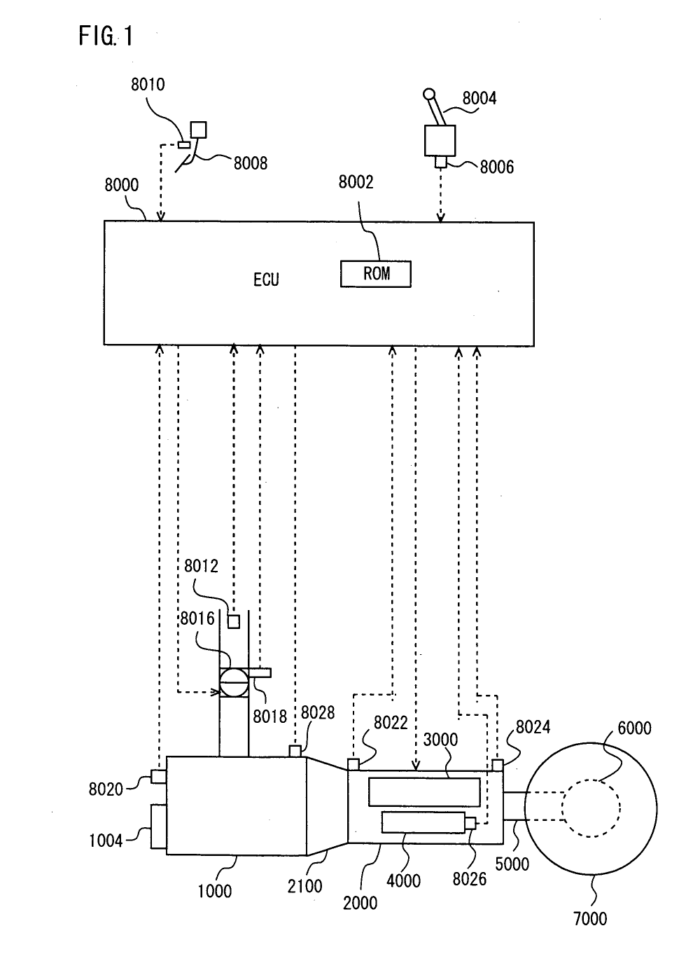

With reference to FIG. 1, a vehicle with a control apparatus according to the embodiment of the present invention installed will be described. This vehicle is an FR (Front engine Rear drive) vehicle. It should be noted that this vehicle may be a vehicle other than the FR vehicle.

The vehicle includes an engine 1000, an automatic transmission 2000, a torque converter 2100, a planetary gear unit 3000 constituting part of automatic transmission 2000, an oil hydraulic circuit 4000 constituting part of automatic transmission 2000, a propeller shaft 5000, a differential gear 6000, rear wheels 7000, and an ECU (Electronic Control Unit) 8000.

Engine 1000 is an internal combustion engine for combusting an air-fuel mixture of fuel injected from an injector (not shown) and the air in a combustion chamber of a cylinder. A piston in the cylinder is pushed down by the combustion and a crankshaft is rotated. An auxiliary machine 1004 such as an alternator and an air conditioner is driven by engine 1000. Output torque of engine 1000 (engine torque TE) is changed in accordance with an actuated amount of an electronic throttle valve 8016, that is, a throttle opening position or the like. It should be noted that a motor may be used as a power source instead of or in addition to engine 1000. Alternatively, a diesel engine may be used. In the diesel engine, output torque is changed in accordance with the valve opening time of the injector (the actuated amount), that is, a fuel injection amount.

Automatic transmission 2000 is coupled to engine 1000 with torque converter 2100 interposed therebetween. Automatic transmission 2000 implements a desired gear so as to shift the revolution number of the crankshaft to a desired revolution number. It should be noted that a CVT (Continuously Variable Transmission) for continuously changing a gear ratio may be installed instead of the automatic transmission implementing a gear. Further, another automatic transmission configured by an constant-meshing type gear shifted by an oil hydraulic actuator or an electric motor may be installed.

Drive force outputted from automatic transmission 2000 is transmitted to right and left rear wheels 7000 through propeller shaft 5000 and differential gear 6000.

A position switch 8006 of a shift lever 8004, an accelerator pedal position sensor 8010 of an accelerator pedal 8008, an air flow meter 8012, a throttle opening position sensor 8018 of electronic throttle valve 8016, an engine speed sensor 8020, an input shaft speed sensor 8022, an output shaft speed sensor 8024, an oil temperature sensor 8026, and a water temperature sensor 8028 are connected to ECU 8000 with a harness and the like interposed therebetween.

A position of shift lever 8004 is detected by position switch 8006, and a signal representing a detection result is transmitted to ECU 8000. The gear of automatic transmission 2000 is automatically implemented in response to the position of shift lever 8004. A driver may select a manual shift mode in which the driver can select any gear in accordance with operations of the driver.

Accelerator pedal position sensor 8010 detects a position of accelerator pedal 8008 and transmits a signal representing a detection result to ECU 8000. Air flow meter 8012 detects an amount of air to be taken in engine 1000 and transmits a signal representing a detection result to ECU 8000.

Throttle opening position sensor 8018 detects an opening position of electronic throttle valve 8016 adjusted by an actuator and transmits a signal representing a detection result to ECU 8000. The amount of air to be taken in engine 1000 is adjusted by electronic throttle valve 8016.

It should be noted that the amount of air to be taken in engine 1000 may be adjusted by a variable valve lift system of changing the lift amount or opening/closing phase of an inlet valve (not shown) or an outlet valve (not shown) instead of or in addition to electronic throttle valve 8016.

Engine speed sensor 8020 detects the revolution number of an output shaft (the crankshaft) of engine 1000 (hereinafter, also referred to as engine revolution number NE) and transmits a signal representing a detection result to ECU 8000. Input shaft speed sensor 8022 detects the input shaft revolution number NI of automatic transmission 2000 (the turbine revolution number NT of torque converter 2100) and transmits a signal representing a detection result to ECU 8000. Output shaft speed sensor 8024 detects the output shaft revolution number NO of automatic transmission 2000 and transmits a signal representing a detection result to ECU 8000.

Oil temperature sensor 8026 detects a temperature (an oil temperature) of oil used for actuating and lubricating automatic transmission 2000 (ATF: Automatic Transmission Fluid) and transmits a signal representing a detection result to ECU 8000.

Water temperature sensor 8028 detects a temperature of coolant of engine 1000 (a water temperature) and transmits a signal representing a detection result to ECU 8000.

ECU 8000 controls devices so that the vehicle is in a desired traveling state based on the signals transmitted from position switch 8006, accelerator pedal position sensor 8010, air flow meter 8012, throttle opening position sensor 8018, engine speed sensor 8020, input shaft speed sensor 8022, output shaft speed sensor 8024, oil temperature sensor 8026, water temperature sensor 8028, and the like, a map and a program stored in a ROM (Read Only Memory) 8002. It should be noted that the program to be executed by ECU 8000 may be stored in a recording medium such as a CD (Compact Disc) and a DVD (Digital Versatile Disc) and distributed on the market. ECU 8000 may be divided into a plurality of ECUs.

In the present embodiment, ECU 8000 controls automatic transmission 2000 so that any of first to eighth forward gears is implemented in the case where a D (drive) range is selected as a shift range of automatic transmission 2000 by placing shift lever 8004 at a D (drive) position. Since any gear among the first to eighth forward gears is implemented, automatic transmission 2000 can transmit the drive force to rear wheels 7000. It should be noted that a gear of a higher speed than the eighth gear may be implemented in the D range. A gear to be implemented is determined based on a shift map preliminarily prepared by an experiment or the like taking the vehicle speed and the accelerator pedal position as parameters. It should be noted that ECU may be divided into a plurality of ECUs.

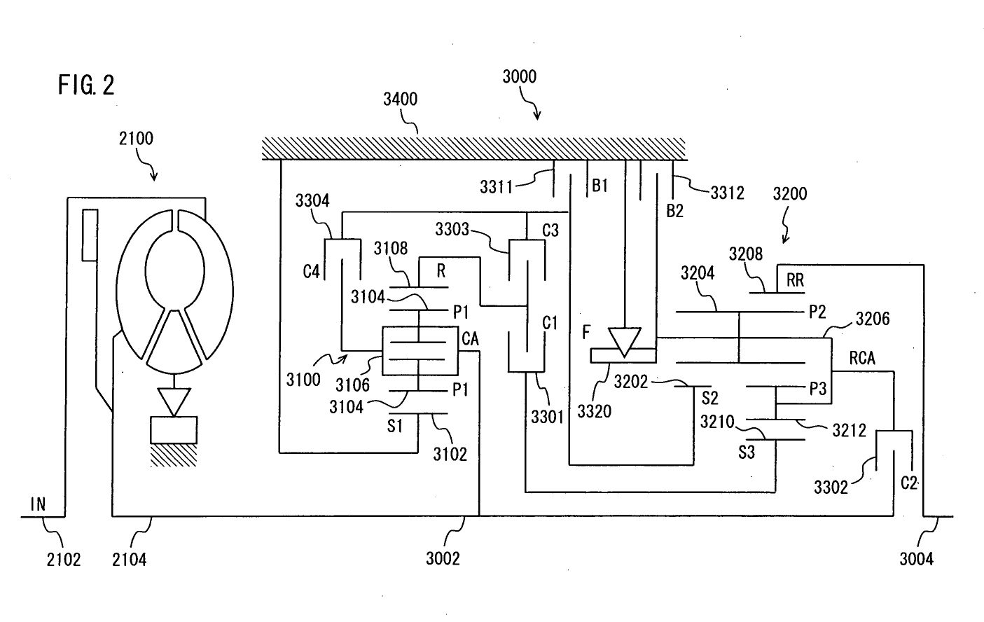

With reference to FIG. 2, planetary gear unit 3000 will be described. Planetary gear unit 3000 is connected to torque converter 2100 having an input shaft 2102 coupled to the crankshaft.

Planetary gear unit 3000 includes a front planetary 3100, a rear planetary 3200, a C1 clutch 3301, a C2 clutch 3302, a C3 clutch 3303, a C4 clutch 3304, a B1 brake 3311, a B2 brake 3312, and a one-way clutch (F) 3320.

Front planetary 3100 is a planetary gear mechanism of a double pinion type. Front planetary 3100 includes a first sun gear (S1) 3102, a pair of first pinion gears (P1) 3104, a carrier (CA) 3106, and a ring gear (R) 3108.

First pinion gears (P1) 3104 are meshed with first sun gear (S1) 3102 and first ring gear (R) 3108. First carrier (CA) 3106 supports first pinion gears (P1) 3104 so that first pinion gears (P1) 3104 can be rotated around an outer axis and also around their own axes.

First sun gear (S1) 3102 is fixed to a gear case 3400 so as not to rotate. First carrier (CA) 3106 is coupled to an input shaft 3002 of planetary gear unit 3000.

Rear planetary 3200 is a Ravigneaux type planetary gear mechanism. Rear planetary 3200 includes a second sun gear (S2) 3202, a second pinion gear (P2) 3204, a rear carrier (RCA) 3206, a rear ring gear (RR) 3208, a third sun gear (S3) 3210, and a third pinion gear (P3) 3212.

Second pinion gear (P2) 3204 is meshed with second sun gear (S2) 3202, rear ring gear (RR) 3208, and third pinion gear (P3) 3212. Third pinion gear (P3) 3212 is meshed with third sun gear (S3) 3210 in addition to second pinion gear (P2) 3204.

Rear carrier (RCA) 3206 supports second pinion gear (P2) 3204 and third pinion gear (P3) 3212 so that second pinion gear (P2) 3204 and third pinion gear (P3) 3212 can be rotated around an outer axis and also around their own axes. Rear carrier (RCA) 3206 is coupled to one-way clutch (F) 3320. Rear carrier (RCA) 3206 cannot be rotated when driving in the first gear (when the vehicle travels by using drive force outputted from engine 1000). Rear ring gear (RR) 3208 is coupled to an output shaft 3004 of planetary gear unit 3000.

One-way clutch (F) 3320 is provided in parallel to B2 brake 3312. That is, an outer race of one-way clutch (F) 3320 is fixed to gear case 3400, and an inner race is coupled to rear carrier (RCA) 3206.

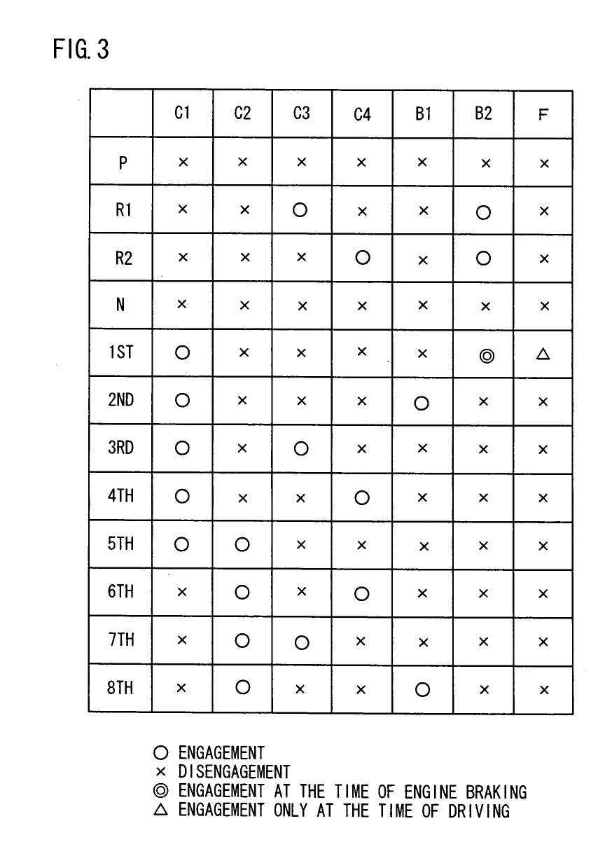

FIG. 3 shows a working table illustrating a relationship between the shift gears and working states of the clutches and the brakes. First to eighth forward gears and first and second reverse gears are implemented by actuating the brakes and the clutches in combinations shown in this working table.

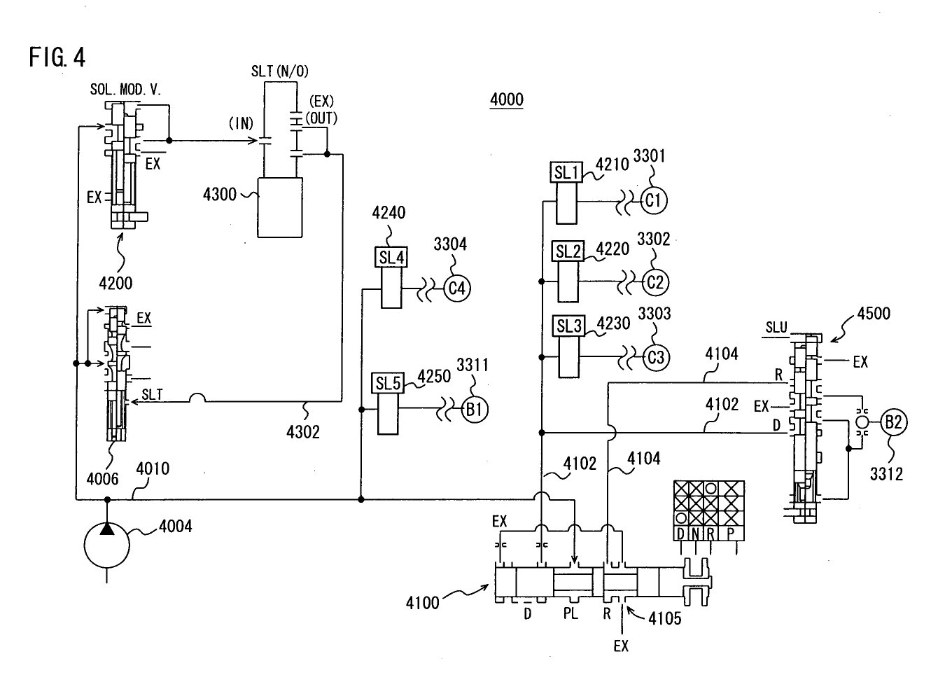

With reference to FIG. 4, a principal portion of oil hydraulic circuit 4000 will be described. It should be noted that oil hydraulic circuit 4000 is not limited to the one described below.

Oil hydraulic circuit 4000 includes an oil pump 4004, a primary regulator valve 4006, a manual valve 4100, a solenoid modulator valve 4200, an SLI linear solenoid (hereinafter, indicated as SL (1)) 4210, an SL2 linear solenoid (hereinafter, indicated as SL (2)) 4220, an SL3 linear solenoid (hereinafter, indicated as SL (3)) 4230, an SL4 linear solenoid (hereinafter, indicated as SL (4)) 4240, an SL5 linear solenoid (hereinafter, indicated as SL (5)) 4250, an SLT linear solenoid (hereinafter, indicated as SLT) 4300, and a B2 control valve 4500.

Oil pump 4004 is coupled to the crankshaft of engine 1000. Oil pump 4004 is driven by rotation of the crankshaft so as to generate oil pressure. The oil pressure generated in oil pump 4004 is regulated by primary regulator valve 4006 so as to generate line pressure.

Primary regulator valve 4006 is actuated taking throttle pressure regulated by SLT 4300 as pilot pressure. The line pressure is supplied to manual valve 4100 through a line pressure oil channel 4010.

Manual valve 4100 includes a drain port 4105. The oil pressure of a D range pressure oil channel 4102 and an R range pressure oil channel 4104 is discharged from drain port 4105. In the case where a spool of manual valve 4100 is at a D position, line pressure oil channel 4010 communicates with D range pressure oil channel 4102. Therefore, the oil pressure is supplied to D range pressure oil channel 4102. At this point, R range pressure oil channel 4104 communicates with drain port 4105. Therefore, R range pressure of R range pressure oil channel 4104 is discharged from drain port 4105.

In the case where the spool of manual valve 4100 is at an R position, line pressure oil channel 4010 communicates with R range pressure oil channel 4104. Therefore, the oil pressure is supplied to R range pressure oil channel 4104. At this point, D range pressure oil channel 4102 communicates with drain port 4105. Therefore, D range pressure of D range pressure oil channel 4102 is discharged from drain port 4105.

In the case where the spool of manual valve 4100 is at an N position, both D range pressure oil channel 4102 and R range pressure oil channel 4104 communicate with drain port 4105. Therefore, the D range pressure of D range pressure oil channel 4102 and the R range pressure of R range pressure oil channel 4104 are discharged from drain port 4105.

The oil pressure supplied to D range pressure oil channel 4102 is eventually supplied to C1 clutch 3301, C2 clutch 3302, and C3 clutch 3303. The oil pressure supplied to R range pressure oil channel 4104 is eventually supplied to B2 brake 3312.

Solenoid modulator valve 4200 regulates the oil pressure to be supplied to SLT 4300 (solenoid modulator pressure) to a constant level taking the line pressure as source pressure.

SL (1) 4210 regulates the oil pressure supplied to C1 clutch 3301. SL (2) 4220 regulates the oil pressure supplied to C2 clutch 3302. SL (3) 4230 regulates the oil pressure supplied to C3 clutch 3303. SL (4) 4240 regulates the oil pressure supplied to C4 clutch 3304. SL (5) 4250 regulates the oil pressure supplied to B1 brake 3311.

SLT 4300 regulates the solenoid modulator pressure in accordance with a control signal from ECU 8000 based on the accelerator pedal position detected by accelerator pedal position sensor 8010 so as to generate the throttle pressure. The throttle pressure is supplied to primary regulator valve 4006 through an SLT oil channel 4302. The throttle pressure is used as the pilot pressure of primary regulator valve 4006.

SL (1) 4210, SL (2) 4220, SL (3) 4230, SL (4) 4240, SL (5) 4250, and SLT 4300 are controlled by the control signal sent from ECU 8000.

B2 control valve 4500 selectively supplies the oil pressure from one of D range pressure oil channel 4102 and R range pressure oil channel 4104 to B2 brake 3312. D range pressure oil channel 4102 and R range pressure oil channel 4104 are connected to B2 control valve 4500. B2 control valve 4500 is controlled by the oil pressure supplied from an SLU solenoid valve (not shown) and the urge of a spring.

In the case where the SLU solenoid valve is ON, B2 control valve 4500 attains the left side state of FIG. 4. In this case, B2 brake 3312 is supplied with oil pressure obtained by regulating the D range pressure taking the oil pressure supplied from the SLU solenoid valve as the pilot pressure.

In the case where the SLU solenoid valve is OFF, B2 control valve 4500 attains the right side state of FIG. 4. In this case, B2 brake 3312 is supplied with the R range pressure.

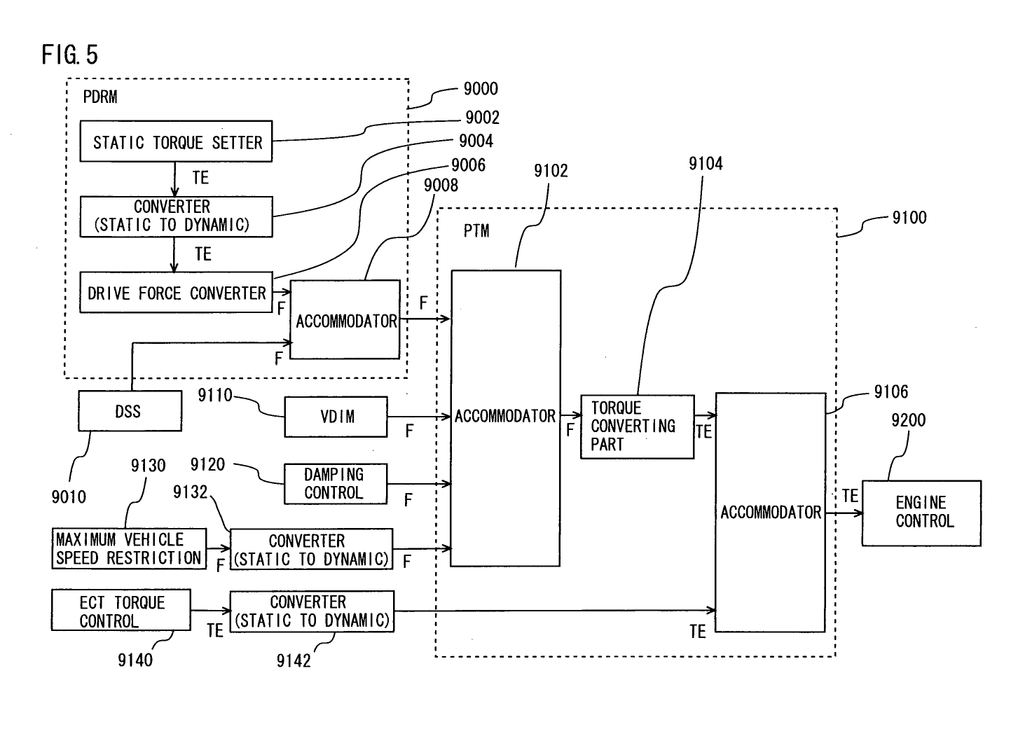

With reference to FIG. 5, a system configuration of the control apparatus according to the present embodiment will be described. “F” indicates the drive force, and “TE” indicates the engine torque, in FIG. 5. It should be noted that functions of the configuration described below may be implemented by either hardware or software.

As shown in FIG. 5, the control apparatus includes a power train driver model (PDRM) 9000, a drivers support system (DSS) 9010, a power train manager (PTM) 9100, a VDIM (Vehicle Dynamics Integrated Management) system 9110, a damping control system 9120, a maximum vehicle speed restricting system 9130, an ECT (Electronic Controlled Transmission) torque controlling system 9140, and an engine controlling system 9200.

Power train driver model 9000 is a model (a function) used for setting demand drive force of the driver relative to the vehicle based on the operations of the driver. In the present embodiment, the demand drive force (a demand value of the drive force) is set from the accelerator pedal position according to an engine torque map predetermined based on results of an experiment, simulation, or the like.

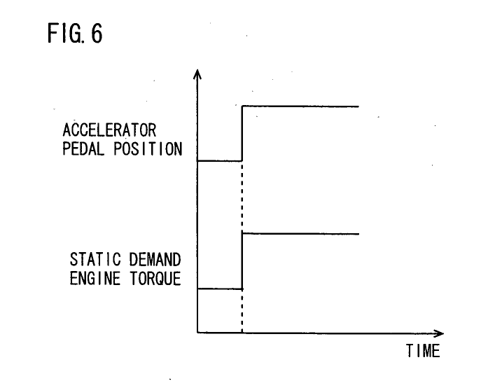

More specifically, static demand engine torque relative to engine 1000 (a demand value of output torque of engine 1000) is set from the accelerator pedal position in a static torque setter 9002. The static demand engine torque indicates demand engine torque in a state where the output torque of engine 1000 is stabilized. The static demand engine torque is determined without consideration of temporal influences such as a response property of the device including throttle valve 8016 and a delay at the time of controlling as shown in FIG. 6.

The static demand engine torque set in static torque setter 9002 is converted into dynamic demand engine torque in a converter 9004. The dynamic demand engine torque indicates demand engine torque in a transition state where the output torque of engine 1000 may change. The dynamic demand engine torque is determined in consideration of the temporal influences such as the response property of the device including electronic throttle valve 8016 and the delay at the time of controlling.

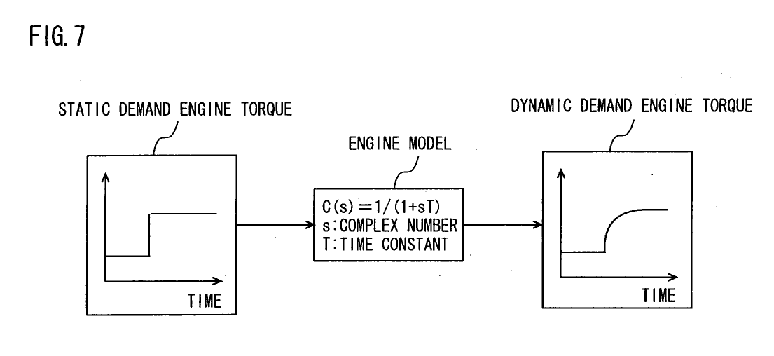

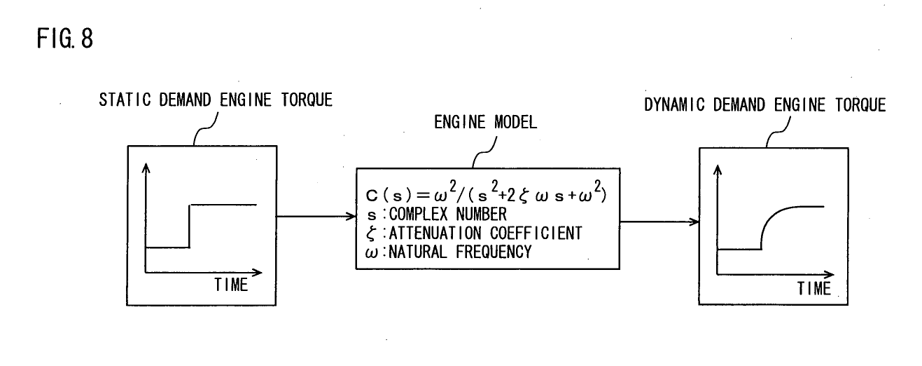

For example, as shown in FIG. 7, the static demand engine torque is converted into the dynamic demand engine torque by adding a delay at the time of controlling (actuating) the device such as throttle valve 8016 using an engine model C (s) represented by a primary delay function. A time constant of the engine model shown in FIG. 7 is changed by the engine revolution number NE and the engine torque. It should be noted that an engine model C (s) represented by a secondary delay function may be used as shown in FIG. 8. These engine models are z-transformed when installed in ECU 8000.

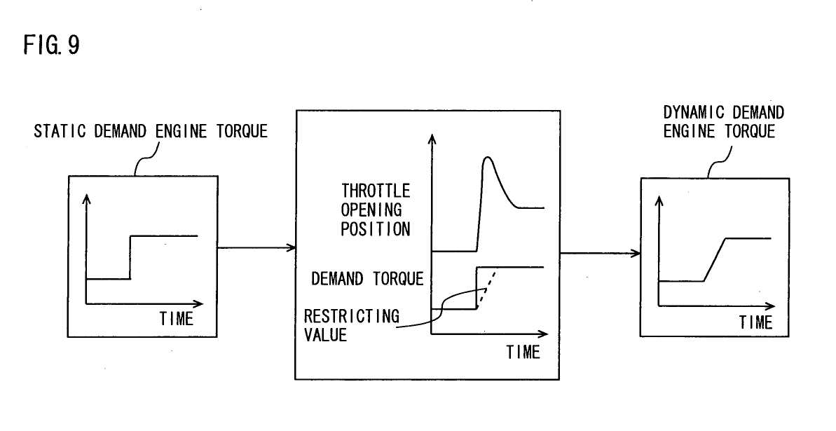

As shown in FIG. 9, the static demand engine torque may be converted into the dynamic demand engine torque by restricting the static demand engine torque with a restricting value determined in accordance with the response property of the device such as throttle valve 8016. The restricting value is predetermined for example by an experiment, a simulation, or the like.

Returning to FIG. 5, the dynamic demand engine torque converted from the static demand engine torque is converted into dynamic demand drive force in a drive force converter 9006. The dynamic demand drive force indicates demand drive force in a transition state where the drive force of the vehicle may change. On the other hand, the static demand drive force indicates demand drive force in a state where the drive force of the vehicle is stabilized.

For example, the demand engine torque is converted into the demand drive force by multiplying the demand engine torque by a current gear ratio of automatic transmission 2000 and a gear ratio of differential gear 6000 and then dividing the same by a radius of rear wheels 7000. It should be noted that a generally well-known technique may be used for a method of converting the torque into the drive force. Therefore, a further detailed description will not be repeated here.

An accommodator 9008 accommodates the dynamic demand drive force converted from the dynamic demand engine torque in drive force converter 9006 and the dynamic demand drive force set by drivers support system 9010. In the present embodiment, larger demand drive force of the dynamic demand drive force converted in drive force converter 9006 and the dynamic demand drive force set by drivers support system 9010 is selected and outputted to power train manager 9100.

Drivers support system 9010 automatically sets the dynamic demand drive force in accordance with the action of the vehicle by a cruise control system, a parking assist system, a pre-crash safety system, and the like.

Power train manager 9100 sets the dynamic demand engine torque finally used for controlling engine 1000 based on the dynamic demand drive force inputted from power train driver model 9000, VDIM system 9110, damping control system 9120, and maximum vehicle speed restricting system 9130, and the dynamic demand engine torque inputted from ECT torque controlling system 9140.

More specifically, an accommodator 9102 accommodates the dynamic demand drive forces inputted from power train driver model 9000, VDIM system 9110, damping control system 9120, and maximum vehicle speed restricting system 9130. In the present embodiment, the minimum demand drive force is selected and outputted to a torque converting part 9104.

The dynamic demand drive force accommodated by accommodator 9102 is converted into the dynamic demand engine torque in torque converting part 9104.

An accommodator 9106 accommodates the dynamic demand engine torque converted from the demand drive force in torque converting part 9104 and the dynamic demand engine torque inputted from ECT torque controlling system 9140. Smaller demand engine torque or larger demand engine torque of the two demand engine torques is selected and outputted to engine controlling system 9200. The demand engine torque to be selected from the smaller demand engine torque and the larger demand engine torque is determined in accordance with an operation state of the vehicle or the like.

Engine controlling system 9200 controls the device provided in engine 1000 for controlling the output torque of engine 1000 such as electronic throttle valve 8016, spark, and an EGR (Exhaust Gas Recirculation) valve in order to realize the dynamic demand engine torque inputted from power train manager 9100.

VDIM system 9110 is a system for integrating VSC (Vehicle Stability Control), TRC (TRaction Control), ABS (Anti lock Brake System), EPS (Electric Power Steering), and the like. The VDIM system 9110 calculates a difference between a traveling image of the driver with regard to control input for an accelerator, steering, and a brake and a vehicle action with regard to various sensor information, and controls the drive force of the vehicle, braking oil pressure, or the like so as to reduce the difference.

The VSC is control of automatically setting an optimal value of the braking oil pressure of wheels, the dynamic demand drive force of the vehicle, or the like so as to ensure stability of the vehicle in the case where a sensor detects a state in which front and rear wheels are likely to skid.

The TRC is control of automatically setting an optimal value of the braking oil pressure of the wheels, the dynamic demand drive force of the vehicle, or the like so as to ensure optimal drive force when a sensor senses idling of drive wheels at the time of starting and accelerating the vehicle on a slippery road surface.

The ABS is a control system of automatically setting an optimal value of the braking oil pressure so as to prevent locking of the wheels. The EPS is a control system of assisting an operation of a steering wheel by force of an electric motor.

The dynamic demand drive force set in VDIM system 9110 is inputted in accommodator 9102 of power train manager 9100.

Damping control system 9120 sets the dynamic demand drive force for reducing pitting and bouncing of the vehicle calculated using a vehicle model from actual drive force of the vehicle or the like. A conventional technique may be used for a method of setting the drive force for reducing the pitting and bouncing of the vehicle. Therefore, a further detailed description will not be repeated here.

Maximum vehicle speed restricting system 9130 sets the static demand drive force for restricting the vehicle speed to be a predetermined maximum vehicle speed or lower, for example, in accordance with a current acceleration and a vehicle speed. The static demand drive force set by maximum vehicle speed restricting system 9130 is converted into the dynamic demand drive force in a convertor 9132.

ECT torque controlling system 9140 sets the static demand engine torque demanded relative to engine 1000 at the time of shifting of automatic transmission 2000. The static demand engine torque set by ECT torque controlling system 9140 is set so as to realize torque-down or torque-up for reducing, for example, shift shock.

The static demand engine torque set by ECT torque controlling system 9140 is converted into the dynamic demand engine torque by a converter 9142.

As mentioned above, according to the control apparatus of the present embodiment, the static demand engine torque is converted into the dynamic demand engine torque and then accommodated in relation to the dynamic demand engine torque set in the other system. The static demand drive force is converted into the dynamic demand drive force and then accommodated in relation to the dynamic demand drive force set in the other system. Accordingly, it is possible to unify a plurality of demand engine torques having different characteristics so as to be the dynamic demand engine torque, and set the demand engine torque in consideration of both the dynamic demand engine torque and the static demand engine torque. Alternatively, it is possible to unify a plurality of demand drive forces having different characteristics so as to be the dynamic demand drive force, and set the demand drive force in consideration of both the dynamic demand drive force and the static demand drive force. The device such as the electronic throttle valve is controlled in accordance with these demand engine torque and demand drive force. Therefore, it is possible to improve control accuracy of the engine.

It should be noted that in the embodiment described above, the static demand engine torque/demand drive force is converted into the dynamic demand engine torque/demand drive force. However, the dynamic demand engine torque/demand drive force may be conversely converted into the static demand engine torque/demand drive force.

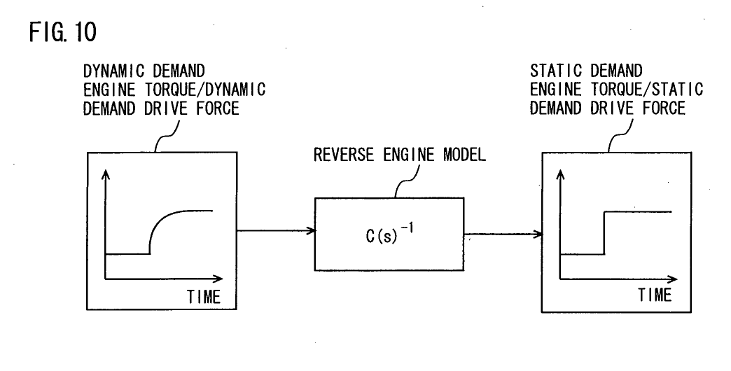

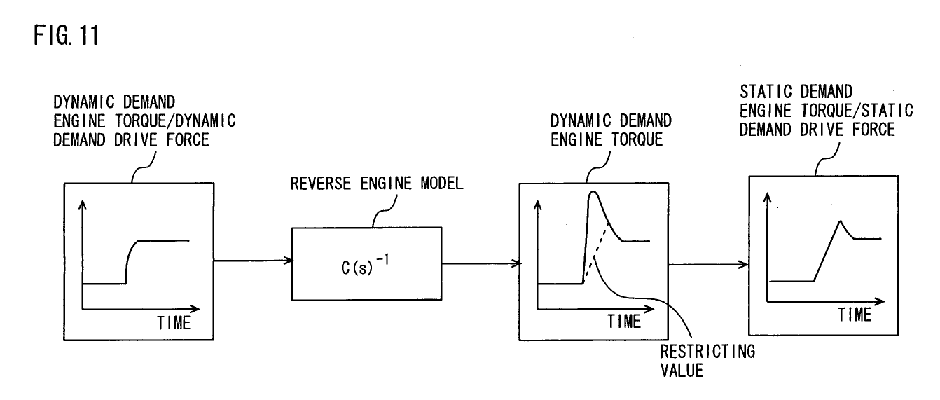

For example, as shown in FIG. 10, the dynamic demand engine torque is converted into the static demand engine torque by subtracting a delay at the time of controlling the device such as electronic throttle valve 8016 from the dynamic demand engine torque/demand drive force using a reverse model C (s)⁻¹ of an engine model C (s) represented by a primary or secondary delay function. As shown in FIG. 11, the dynamic demand engine torque is converted into the static demand engine torque by subtracting a delay at the time of controlling the device such as electronic throttle valve 8016 from the dynamic demand engine torque/demand drive force using a reverse model C (s)⁻¹ of the engine model C (s) represented by the primary or secondary delay function and restricting the dynamic demand engine torque with a restricting value determined in accordance with a limit value of the actuated amount of the device such as electronic throttle valve 8016.

In this case, the demand engine torque/demand drive force unified to be the static demand engine torque/demand drive force is accommodated so as to set final demand engine torque/demand drive force.

It is clearly understood that the embodiments shown here are by way of illustration and example in all respects and are not to be taken by way of limitation. The scope of the present invention is interpreted by the terms of the appended claims and not by the above description, and all changes and modifications are to be encompassed without departing from the equivalent meaning and scope of the appended claims.

1-21. (canceled)

22. A control apparatus for a power source with an output torque changed in accordance with an actuated amount of a device, comprising:
an accommodator that selects a dynamic demand value of drive force from a plurality of dynamic demand values of drive force;
a converter that converts the selected dynamic demand value of drive force to a first, dynamic demand value of said output torque;
a second setter that sets a second, static demand value of said output torque;
a converter that converts said second demand value into a third, dynamic demand value of said output torque;
a third setter that sets a fourth demand value of said output torque based on said first demand value and said third demand value; and
a controller that controls said device in accordance with said fourth demand value.

23. The control apparatus for the power source according to claim 22, wherein
said third setter sets one of said first demand value and said third demand value as said fourth demand value.

24. The control apparatus for the power source according to claim 22, wherein
said converter converts said second demand value into said third demand value by adding a delay at the time of controlling said device to said second demand value.

25. The control apparatus for the power source according to claim 22, wherein
said converter converts said second demand value into said third demand value by restricting said second demand value in accordance with a response property of said device.

26. A control method for a power source with an output torque changed in accordance with an actuated amount of a device, comprising the steps of:
selecting a dynamic demand value of drive force from a plurality of dynamic demand values of drive force;
converting the selected dynamic demand value of drive force to a first, dynamic demand value of said output torque;
setting a second, static demand value of said output torque;
converting said second demand value into a third, dynamic demand value of said output torque;
setting a fourth demand value of said output torque based on said first demand value and said third demand value; and
controlling said device in accordance with said fourth demand value.

27. The control method for the power source according to claim 26, wherein
the step of setting said fourth demand value of said output torque includes the step of setting one of said first demand value and said third demand value as said fourth demand value.

28. The control method for the power source according to claim 26, wherein
the step of converting said second demand value into said third demand value includes the step of converting said second demand value into said third demand value by adding a delay at the time of controlling said device to said second demand value.

29. The control method for the power source according to claim 26, wherein
the step of converting said second demand value into said third demand value includes the step of converting said second demand value into said third demand value by restricting said second demand value in accordance with a response property of said device.

30. A control apparatus for a power source with an output torque changed in accordance with an actuated amount of a device, comprising:
means for selecting a dynamic demand value of drive force from a plurality of dynamic demand values of drive force;
means for converting the selected dynamic demand value of drive force to a first, dynamic demand value of said output torque;
means for setting a second, static demand value of said output torque;
converting means for converting said second demand value into a third, dynamic demand value of said output torque;
setting means for setting a fourth demand value of said output torque based on said first demand value and said third demand value; and
means for controlling said device in accordance with said fourth demand value.

31. The control apparatus for the power source according to claim 30, wherein
said setting means includes means for setting one of said first demand value and said third demand value as said fourth demand value.

32. The control apparatus for the power source according to claim 30, wherein
said converting means includes means for converting said second demand value into said third demand value by adding a delay at the time of controlling said device to said second demand value.

33. The control apparatus for the power source according to claim 30, wherein
said converting means includes means for converting said second demand value into said third demand value by restricting said second demand value in accordance with a response property of said device.
